(19) United States
(12) Patent Application Publication
(10) Pub. No.: US 2024/0388963 A1
(43) Pub. Date: Nov. 21, 2024

(54) ENHANCING SPLIT BEARER DATA TRANSFER

(71) Applicant: Nokia Technologies Oy, Espoo (FI)

(72) Inventors: Henri Markus KOSKINEN, Espoo (FI); Amaanat ALI, Espoo (FI)

(21) Appl. No.: 18/571,016

(22) PCT Filed: Jun. 16, 2021
(86) PCT No.: PCT/EP2021/066252

§ 371 Date: Dec. 15, 2023

(51) Int. Cl. H04W 28/082; H04L 47/36

(52) U.S. Cl. CPC H04W 28/082; H04L 47/36

(57) ABSTRACT

There is provided an apparatus configured to perform method comprising: supporting a split bearer involving a first entity associated with a primary path of the split bearer and a second entity associated with secondary path of the split bearer, wherein the first entity and the second entity are configured for data transfer; determining a total amount of data volume for the data transfer; if the total amount of data volume for the data transfer is greater than or equal to a threshold value of the split bearer, submitting a Packet Data Convergence Protocol, PDCP, protocol data unit, PDU, to either the first entity or the second entity; if the total amount of data volume for the data transfer is less than the threshold value of the split bearer, submitting the PDCP PDU to the first entity if the primary path is available to use, and submitting the PDCP PDU to the second entity if the primary path is not available to use.

### FIELD

following exemplary embodiments relate to wireless communication.

### BACKGROUND

Split bearer can be used in modern wireless communication networks. Further enhancements to data transfer using split bearer may be beneficial for the efficiency of such wireless communication networks.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided a method for a user equipment (UE) the method comprising: supporting a split bearer involving a first entity associated with a primary path of the split bearer and a second entity associated with secondary path of the split bearer, wherein the first entity and the second entity are configured for data transfer; determining a total amount of data volume for the data transfer; if the total amount of data volume for the data transfer is greater than or equal to a threshold value of the split bearer, submitting a Packet Data Convergence Protocol (PDCP) protocol data unit (PDU) to either the first entity or the second entity; if the total amount of data volume for the data transfer is less than the threshold value of the split bearer, submitting the PDCP PDU to the first entity if the primary path is available to use, and submitting the PDCP PDU to the second entity if the primary path is not available to use.

In an embodiment, the first entity is a first Radio Link Control (RLC) entity and the second entity is a second RLC entity.

In an embodiment, the first entity is a first RLC entity and the second entity is a wireless local area network (WLAN) aggregation entity. In an embodiment, the WLAN aggregation entity is a Radio Access Network (RAN)-WLAN Aggregation Adaptation Protocol entity. In an embodiment, said RAN comprises Long Term Evolution (LTE) and/or New Radio (NR). In an embodiment, the WLAN aggregation entity is an LTE-WLAN Aggregation Adaptation Protocol (LWAAP) entity.

In an embodiment, if the total amount of data volume for the data transfer is less than the threshold value of the split bearer, the PDCP PDU is submitted to both the first entity and the second entity if the primary path is not available to use.

In an embodiment, if the total amount of data volume for the data transfer is less than the threshold value of the split bearer, the PDCP PDU is submitted only to the second entity if the primary path is not available to use.

In an embodiment the primary path is not available and the unavailability is caused by a temporary condition.

In an embodiment the temporary condition is associated with MAC entity of the primary path.

In an embodiment, the temporary condition is caused by lack of uplink time alignment.

In an embodiment, the temporary condition is caused by a non-completed random-access procedure.

In an embodiment, the temporary condition is caused by a reset of the MAC entity.

In an embodiment, the temporary condition is indicated by the MAC entity by sending an indication to a PDCP entity.

In an embodiment, the indication causes PDCP entity to stop submitting one or more PDUs to the primary path.

In an embodiment, the temporary condition is determined to be over, the method further comprising: if the total amount of data volume for the data transfer is less than the threshold value of the split bearer, preventing submitting a further PDCP PDU to the second entity, and submitting the further PDCP PDU to the first entity.

In an embodiment, the total amount of data volume for the data transfer comprises a total amount of PDCP data volume and data volume pending for initial transmission in the first entity and the second entity. If first and second entities are RLC entities, the total amount of data volume for the data transfer comprises a total amount of PDCP data volume and RLC data volume pending for initial transmission in the first RLC entity and the second RLC entity.

In an embodiment, the method further comprises: receiving, from a network node, a split bearer configuration that configures the UE, if the total amount of data volume for the data transfer is less than the threshold value of the split bearer, to submit the PDCP PDU to the first entity if the primary path is available to use, and to submit the PDCP PDU to the second entity if the primary path is not available to use.

According to an aspect, there is provided a method for a network node, the method comprising: determining a configuration for a split bearer for a user equipment (UE) wherein the split bearer involves a first entity associated with a primary path of the split bearer and a second entity associated with secondary path of the split bearer, and wherein the first entity and the second entity are configured for data transfer; and transmitting the split bearer configuration to the UE, wherein the split bearer configuration causes the UE, if the total amount of data volume for a data transfer is less than the threshold value of the split bearer, to submit a Packet Data Convergence Protocol (PDCP) protocol data unit (PDU) to the first entity if the primary path is available to use, and to submit the PDCP PDU to the second entity if the primary path is not available to use.

In an embodiment, the first entity is a first RLC entity and the second entity is a second RLC entity.

In an embodiment, the first entity is a first RLC entity and the second entity is a WLAN aggregation entity. In an embodiment, the WLAN aggregation entity is a RAN-WLAN Aggregation Adaptation Protocol entity. In an embodiment, said RAN comprises Long Term Evolution (LTE) and/or New Radio (NR). In an embodiment, the WLAN aggregation entity is a LTE-WLAN Aggregation Adaptation Protocol (LWAAP) entity.

According to an aspect, there is provided a method for a UE, the method comprising: supporting a split bearer involving a first RLC entity associated with a primary path of the split bearer and a second RLC entity associated with secondary path of the split bearer, wherein the first RLC entity and the second RLC entity are configured for data transfer; determining a total amount of data volume for the data transfer; if the total amount of data volume for the data transfer is greater than or equal to a threshold value of the split bearer, submitting a PDCP protocol data unit PDU to either the first RLC entity or the second RLC entity; if the total amount of data volume for the data transfer is less than the threshold value of the split bearer, submitting the PDCP PDU to the first RLC entity if the primary path is available to use, and submitting the PDCP PDU to the second RLC entity if the primary path is not available to use.

According to an aspect, there is provided an apparatus comprising means for performing: supporting a split bearer involving a first entity associated with a primary path of the split bearer and a second entity associated with secondary path of the split bearer, wherein the first entity and the second entity are configured for data transfer; determining a total amount of data volume for the data transfer; if the total amount of data volume for the data transfer is greater than or equal to a threshold value of the split bearer, submitting a Packet Data Convergence Protocol, PDCP, protocol data unit, PDU, to either the first entity or the second entity; if the total amount of data volume for the data transfer is less than the threshold value of the split bearer, submitting the PDCP PDU to the first entity if the primary path is available to use, and submitting the PDCP PDU to the second entity if the primary path is not available to use.

According to an aspect, there is provided an apparatus comprising means for performing: determining a configuration for a split bearer for a user equipment, UE, wherein the split bearer involves a first entity associated with a primary path of the split bearer and a second entity associated with secondary path of the split bearer, and wherein the first entity and the second entity are configured for data transfer; and transmitting the split bearer configuration to the UE, wherein the split bearer configuration causes the UE, if the total amount of data volume for a data transfer is less than the threshold value of the split bearer, to submit a Packet Data Convergence Protocol, PDCP, protocol data unit, PDU, to the first entity if the primary path is available to use, and to submit the PDCP PDU to the second entity if the primary path is not available to use.

According to an aspect, there is provided a computer program product comprising program instructions which, when loaded into an apparatus, execute a method comprising: supporting a split bearer involving a first entity associated with a primary path of the split bearer and a second entity associated with secondary path of the split bearer, wherein the first entity and the second entity are configured for data transfer; determining a total amount of data volume for the data transfer; if the total amount of data volume for the data transfer is greater than or equal to a threshold value of the split bearer, submitting a Packet Data Convergence Protocol, PDCP, protocol data unit, PDU, to either the first entity or the second entity; if the total amount of data volume for the data transfer is less than the threshold value of the split bearer, submitting the PDCP PDU to the first entity if the primary path is available to use, and submitting the PDCP PDU to the second entity if the primary path is not available to use.

According to an aspect, there is provided a computer program product comprising program instructions which, when loaded into an apparatus, execute a method comprising: determining a configuration for a split bearer for a user equipment, UE, wherein the split bearer involves a first entity associated with a primary path of the split bearer and a second entity associated with secondary path of the split bearer, and wherein the first entity and the second entity are configured for data transfer; and transmitting the split bearer configuration to the UE, wherein the split bearer configuration causes the UE, if the total amount of data volume for a data transfer is less than the threshold value of the split bearer, to submit a Packet Data Convergence Protocol, PDCP, protocol data unit, PDU, to the first entity if the primary path is available to use, and to submit the PDCP PDU to the second entity if the primary path is not available to use.

### BRIEF DESCRIPTION OF THE DRAWINGS

In the following, various exemplary embodiments will be described in greater detail with reference to the accompanying drawings, in which

FIG. 1 illustrates a cellular communication network system to which embodiments may be applied;

FIG. 2 illustrates a split bearer configuration according to some examples;

FIGS. 3 and 4 illustrate block diagrams according to some embodiments;

FIGS. 5, 6, and 7 illustrate some embodiments;

FIG. 8 illustrates a signal diagram according to an embodiment; and

FIGS. 9 and 10 illustrate apparatuses according to some embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

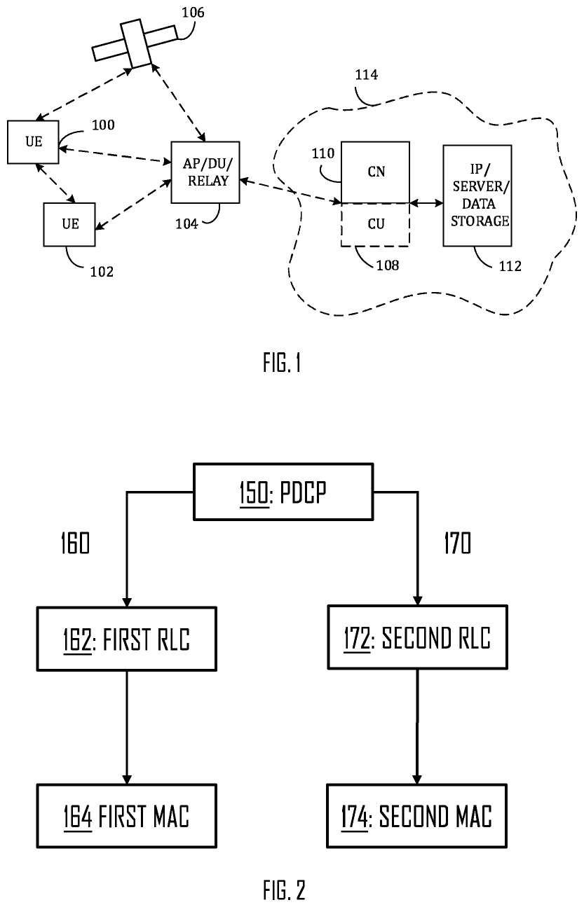

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink (UL) or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The (e/g)NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station. The self-backhauling relay node may also be called an integrated access and backhaul (IAB) node. The IAB node may comprise two logical parts: a mobile termination (MT) part, which takes care of the backhaul link(s) (i.e. link(s) between IAB node and a donor node, also known as a parent node) and a distributed unit (DU) part, which takes care of the access link(s), i.e. child link(s) between the IAB node and UE(s) and/or between the IAB node and other IAB nodes (multi-hop scenario).

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHZ, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home (e/g)nodeB.

Furthermore, the (e/g)nodeB or base station may also be split into: a radio unit (RU) comprising a radio transceiver (TRX), i.e. a transmitter (TX) and a receiver (RX); one or more distributed units (DUs) that may be used for the so-called Layer 1 (L1) processing and real-time Layer 2 (L2) processing; and a central unit (CU) or a centralized unit that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the (e/g)nodeB or base station. The DU may be defined as a logical node hosting radio link control (RLC), medium access control (MAC) and/or physical (PHY) layers of the (e/g)nodeB or base station. The operation of the DU may be at least partly controlled by the CU. The CU may comprise a control plane (CU-CP), which may be defined as a logical node hosting the RRC and the control plane part of the PDCP protocol of the CU for the (e/g)nodeB or base station. The CU may further comprise a user plane (CU-UP), which may be defined as a logical node hosting the user plane part of the PDCP protocol and the SDAP protocol of the CU for the (e/g)nodeB or base station.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

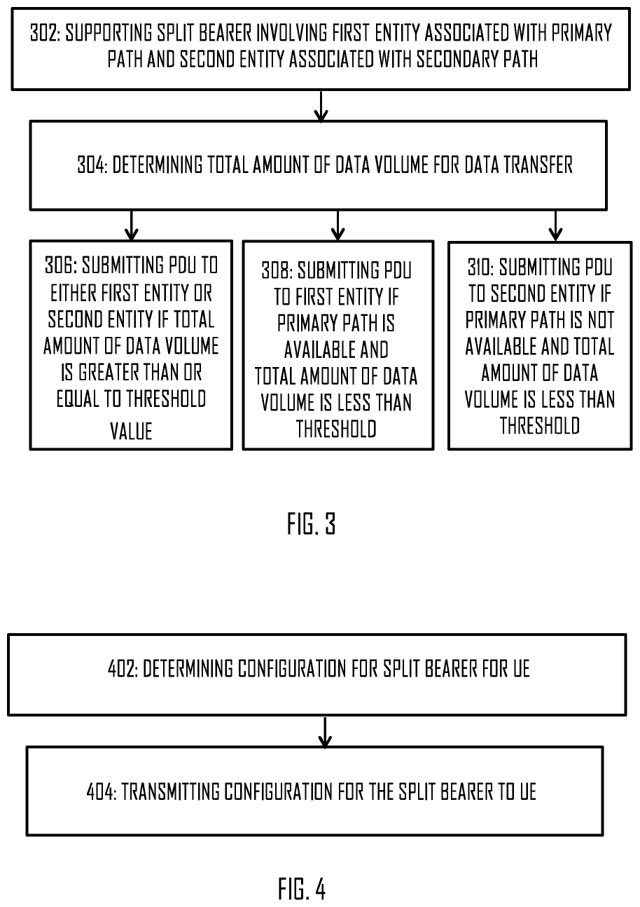

One way to increase data transmission capacity in systems, like the one described as an example with reference to FIG. 1, is use of split radio bearer (hereinafter split bearer). An example of split bearer configuration is shown in FIG. 2. Referring to FIG. 2, split bearer configuration may enable UE, configured with such split bearer, to utilize two transmission paths 160, 170 for transmitting data. Packet Data Convergence Protocol (PDCP) protocol data units (PDUs) are used herein as one example. PDCP layer may comprise, at the UE, PDCP entity 150. PDCP entity 150 may control to which transmission path a PDU is sent for transmission.

For example, a first transmission path 160 may comprise a first radio link control (RLC) entity 162 and a first Medium Access Control (MAC) entity 164. Similarly, second transmission path 170 may comprise a second RLC entity 172 and a second MAC entity 174. As the skilled person understands, MAC layer may be used to transmit within MAC PDUs MAC Service Data Units (SDUs) received from RLC layer, which may comprise one or more RLC PDUs. As discussed, these different entities on different protocol layers may be comprised in the UE, for example, as logical entities realized by physical resources.

UE (e.g. UE 100 or UE 102 may be some examples of UEs) may be configured to utilize master cell group (MCG) and secondary cell group (SCG) for reporting and transmitting uplink data on the split bearer. At this point it is noted that the split bearer configuration may comprise primary path and split secondary path (or simply secondary path). These may sometimes be referred to as primary leg and secondary leg, respectively. For example, RLC entity of the primary path may be denoted as primary RLC entity.

Primary and secondary paths may not necessarily be fixed. Thus, MCG or SCG may be set as primary path and thus the other may be set as secondary path. So, for example, if MCG is set as primary path, SCG may be set as secondary path. And if SCG is set as primary path, MCG may be set as secondary path.

In the following examples, we assume that first path 160 is the primary path and second path 170 is the secondary path. At least the following situations can be observed:
MCG is set as primary path in the split bearer configuration. Thus, MCG RLC entity may be the primary RLC entity. Thus, first RLC entity 162 may be associated with MCG and thus acts as MCG RLC entity. In this case, SCG is secondary path, and SCG RLC entity is the secondary RLC entity (i.e. second RLC entity 172 may act as SCG RLC entity).
SCG is set as primary path in the split bearer configuration. Thus, SCG RLC entity may be the primary RLC entity. Thus, first RLC entity 162 may be associated with SCG and thus acts as SCG RLC entity. In this case, MCG is secondary path, and MCG RLC entity is the secondary RLC entity (i.e. second RLC entity 172 may act as MCG RLC entity).

It is noted that these first and second paths 160, 170 should be understood as examples.

Currently, the UE may utilize either MCG or SCG to transmit UL data if the total amount of PDCP data volume and RLC data volume pending for initial transmission in the primary RLC entity and the split secondary RLC entity is equal to or larger than ul-DataSplitThreshold. This assumes that the secondary path and thus secondary RLC entity is configured for the UE. So, basically the secondary RLC entity (or secondary path) may additionally be used if data volume is equal to or exceeds the given threshold. Basically, the UE may, for a given PDU, select which one of the two paths it uses to transmit said PDU. However, if total amount is less than ul-DataSplitThreshold, the UE may utilize the primary RLC entity, but not the secondary RLC entity.

Moreover, Radio Resource Control (RRC) signalling may be used to configure to the UE which RLC (MCG or SCG) is the primary one and which the secondary one, as well as the parameter ul-DataSplitThreshold. Thus, network may configure the UE with the split bearer configuration, such as the one discussed herein. Hence, PDCP entity 150 may transfer PDUs to either primary path or secondary path, or just primary path. However, this kind of procedure may be harmful in meeting stringent latency requirements, for example. There has been some discussion, such as in US20210099977 (incorporated herein in its entirety as a reference in those legislations in which it is allowable), about situations in which SCG is set as primary path and SCG is failing or has failed. To address this problem, said reference teaches that the UL split bearer may be configured to send new data only on the MCG irrespective of the primary path and ul-DataSplitThreshold. However, such solution fails to provide much needed benefits from the latency requirement perspective, and also limits the possibilities of the split bearer configuration. That is, the UE is restricted to utilize only one path if only MCG is allowed to be used. In the example of FIG. 2 it would mean that only one of the paths 160, 170 is used even though both would be configured for the UE and total amount of data would be equal or more than said ul-DataSplitThreshold. Hence, there seems to be room to further develop the used solutions.

There is provided a solution to enhance split bearer configuration. The described solution may reduce experienced latency at least in some cases in which the primary path is unavailable.

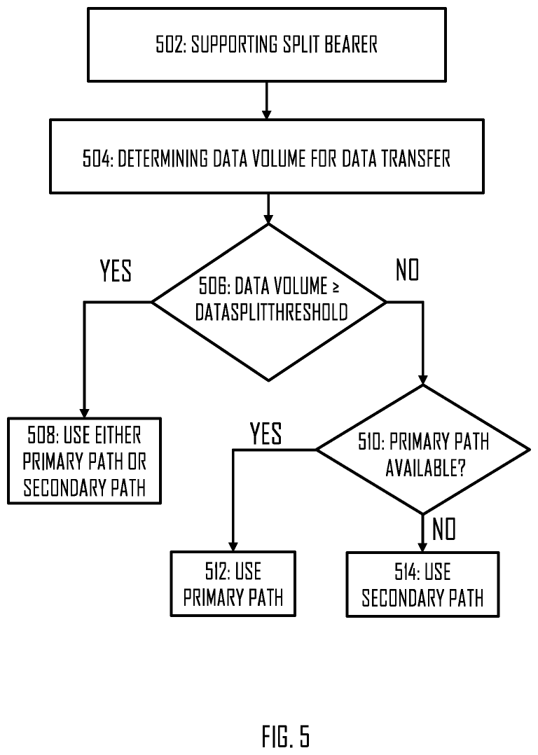

FIGS. 3 and 4 illustrate flow diagrams according to some embodiments. Referring to FIG. 3, a method for a user equipment is proposed, the method comprising: supporting a split bearer involving a first RLC entity 162 associated with a primary path of the split bearer and a second RLC entity 172 associated with secondary path of the split bearer, wherein the first RLC entity 162 and the second RLC entity 172 are configured for data transfer (block 302); determining a total amount of data volume for the data transfer (block 304); if the total amount of data volume for the data transfer is greater than or equal to a threshold value of the split bearer, submitting a PDCP PDU to either the first RLC entity 162 or the second RLC entity 172 (block 306); and if the total amount of data volume for the data transfer is less than the threshold value of the split bearer, submitting the PDCP PDU to the first RLC entity 162 if the primary path is available to use (block 308), and submitting the PDCP PDU to the second RLC entity 172 if the primary path is not available to use (block 310).

As shown in FIG. 3, the process may continue from block 304 to one of blocks 306, 308 and 310 according to the described rules. Thus, for example, for a given PDU, the process may continue from block 304 to block 306, 308, or 310, but not to all blocks.

Referring to FIG. 4, a method for a network node is proposed, the method comprising: determining a configuration for a split bearer for a UE, wherein the split bearer involves a first RLC entity 162 associated with a primary path of the split bearer and a second RLC entity 172 associated with secondary path of the split bearer, and wherein the first RLC entity 162 and the second RLC entity 172 are configured for data transfer (block 402); transmitting the configuration for the split bearer to the UE, wherein the configuration causes the UE, if the total amount of data volume for a data transfer is less than the threshold value of the split bearer, to submit a PDCP PDU to the first RLC entity 162 if the primary path is available to use, and to submit the PDCP PDU to the second RLC entity 172 if the primary path is not available to use (block 404).

UE may refer to UE 100 or UE 102, for example. Network node may refer to network node 104, for example. Moreover, it is noted that first and second RLC entities are used herein as examples. As described below, the solution may be applicable to other scenarios as well.

With the proposed solution, the split bearer configuration (e.g. the one discussed with respect to FIG. 2) may be more suitable for reducing latency in those cases where data volume is less than network configured ul-DataSplitThreshold (or simply datasplitthreshold) and primary path is unavailable. That is, if primary path becomes unavailable and data volume is less than said datasplitthreshold, the data transmission may be continued by using the secondary path. So, for example, if MCG is the primary path, and thus MCG RLC entity is set as primary RLC entity, and SCG is then secondary path and SCG RLC entity is secondary RLC entity, the PDCP entity 150 may normally submit PDUs to the MCG RLC entity if data volume is less than datasplitthreshold. However, if MCG path fails e.g. due to MCG MAC entity failure, the PDU transmission may continue fluently as PDCP entity 150 may start to submit PDUs to the secondary RLC entity. Similar logic applies in cases where MCG is the secondary path and the SCG is the primary path. I.e. it is not the MCG or SCG that determines the transmission, but PDCP 150 may submit PDUs to primary path and/or secondary path according to the defined rules.

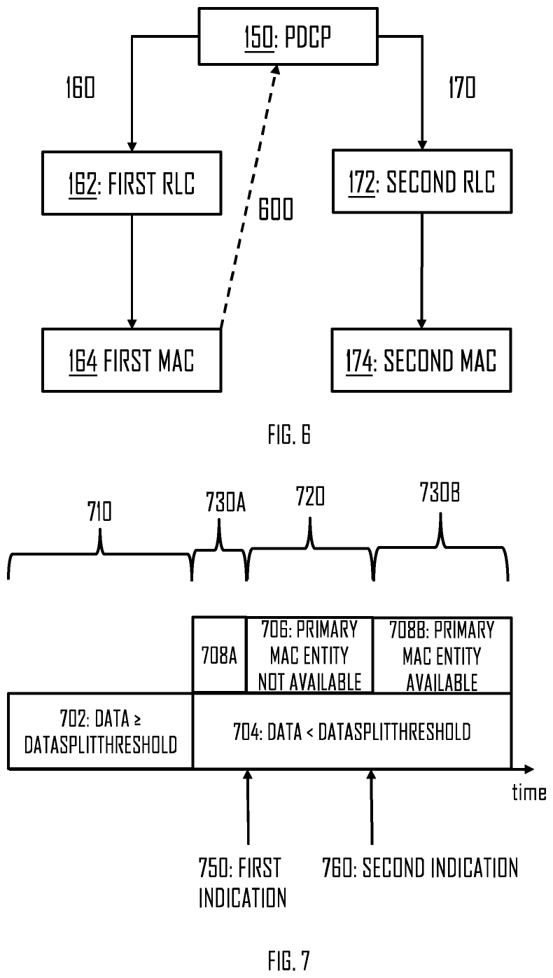

Let us then look closer on some embodiments. FIG. 5 illustrates an embodiment. Referring to FIG. 5, in block 502 UE may support split bearer configuration similarly as in block 302.

In block 504, the UE may determine total amount of data volume for data transfer similarly as in block 304. According to an embodiment, the total amount of data volume for the data transfer comprises a total amount of PDCP data volume and RLC data volume pending for transmission in the primary RLC entity and the secondary RLC entity. Thus, in this example embodiment, the total data volume may comprise data pending for initial transmission and retransmission. In an embodiment, the total amount of data volume for the data transfer comprises a total amount of PDCP data volume and RLC data volume pending for initial transmission in the primary RLC entity and the secondary RLC entity. Thus, the total data volume may not comprise data pending for retransmission, for example. It is noted that total amount of data volume is sometimes referred to simply as data volume herein.

In block 506, the UE may determine whether the total amount of data volume for the data transfer is greater than or equal to the threshold value of the split bearer. Threshold may refer to datasplitthreshold. If the data volume is equal to or exceeds said threshold, process may continue to block 508. If the data volume is less, process may continue to block 510.

In block 508, the UE may submit a PDCP PDU to either the first RLC entity 162 or the second RLC entity 172. I.e. to primary or secondary path. Selection of to which entity the PDU is transmitted may be done by the UE.

In block 510, the UE may determine whether or not the primary path is available. I.e. as first RLC entity 162 is the primary RLC entity, the UE may determine whether or not the first path 160 is available. If it is available, process may continue to block 512. If it is not available, process may continue to block 514.

In block 512, the UE may submit the PDCP PDU to the first RLC entity 162, i.e. transmit PDU using the primary path. This may mean that the UE uses only the primary path to transmit PDUs. As described, primary path may be associated with SCG or MCG depending on the configuration.

In block 514, the UE may submit the PDCP PDU to the second RLC entity 172, i.e. transmit PDU using the secondary path. In an embodiment, prior to submitting the PDCP PDU to the second RLC entity 172, the UE determines whether or not the secondary path is available. I.e. as second RLC entity 172 is the secondary RLC entity, the UE may determine whether or not the second path 170 is available.

In an embodiment, if the total amount of data volume for the data transfer is less than the threshold value of the split bearer, the PDCP PDU may be submitted to both the first entity and the second entity if the primary path is not available to use. This may further help to enhance reliability of the proposed solution as the duplicate PDU(s) may be transmitted also from the primary path after the primary bath is again available to use.

In an embodiment, if the total amount of data volume for the data transfer is less than the threshold value of the split bearer, the PDCP PDU may be submitted to the second entity if the primary path is not available to use, but not to the first entity. This may further help to enhance resource efficiency of the proposed solution.

In an embodiment, if the total amount of data volume for the data transfer is less than the threshold value of the split bearer, the PDCP PDU may be submitted to the first entity if the primary path is available to use, but not to the second entity.

The PDU submission decision by the UE may be performed at the PDCP entity 150. I.e. PDCP entity 150 may decide, based on the criteria explained herein, to which path 160, 170 the PDU is transmitted or submitted. For this purpose, in some embodiments, the PDCP entity 150 may receive an indication about availability of the primary path. For example, indication may indicate either one of primary path being available or not being available. In some example embodiments, this indication is transmitted by the first MAC entity 164, i.e. the primary MAC entity. It is possible that the first MAC entity 164 directly indicates to the PDCP entity 150 about the availability of the primary path. However, in some embodiments the indication is transmitted to the first RLC 162 which may in turn indicate the availability to the PDCP entity 150. One example, of primary MAC (i.e. first MAC 162) directly indicating the availability to the PDCP entity 150 may be seen in FIG. 6 illustrating an embodiment. The indication is shown with arrow 600.

One reason that influences availability of the primary path may be the availability of the primary MAC entity. Thus, the indication may be a UE-internal indication sent by a MAC entity associated with the primary path. The indication may indicate that the MAC entity is uncapable of transmitting one or more SDUs. Hence, the primary path may not be available.

In an embodiment, the unavailability of the MAC entity (e.g. first MAC entity 164 being the primary MAC entity) is caused by lack of uplink time alignment. The lack of time alignment may be caused by expiry of a time-alignment timer at the UE due to the UE not having received timing-advance commands from the network for an extended period of time.

In an embodiment, the unavailability of the MAC entity (e.g. first MAC entity 164 being the primary MAC entity) is caused by a non-completed random-access procedure. For example, the random-access procedure may need to be performed/finished before transmission of MAC SDUs can continue. For example, this may happen when SCG RLC is configured as the primary RLC and Primary Secondary Cell (PSCell) change takes place while security key of the split bearer remains unchanged (such as when the network-side PDCP entity of the bearer is at the Master Node, which is the e/gNB controlling the MCG).

In an embodiment, the unavailability of the MAC entity (e.g. first MAC entity 164 being the primary MAC entity or simply MAC entity to which primary RLC is mapped) is caused by a reset of MAC. MAC here may refer to the MAC entity; i.e. the first MAC entity 164 may need to be reset for some reason. One example reason for MAC reset may be a failure occurring at a reconfiguration with synchronization. This may sometimes be referred to as reconfiguration with synchronization failure or reconfiguration with sync failure. Such failure may be caused e.g. by mobility failure. One other example reason for MAC reset may be radio link failure (RLF). That is, if RLF is experienced, MAC may need to be reset. In general, reset of the MAC may cause the MAC entity to be unavailable and thus the primary path may be unavailable also. It is noted that RLF causing the MAC reset may be associated with the primary path. Hence, such RLF may not cause, at least in some examples, reset of MAC entity associated with secondary path. I.e. the RLF may not be associated with secondary path.

C. or mobility failure),

The availability of the primary path may change. Thus, in one example, the primary path not being available is caused by a temporary condition. Especially in these cases, the MAC indication may be beneficial to indicate the availability (or simply the temporary condition) to the PDCP entity 150. In some examples, the indication indicates that the primary path is not available. On the other hand, the indication may indicate that the primary path is available. For example, if unavailability is indicated with first indication, a second indication may be sent to indicate that the primary path is again available. So, in general, the indication may indicate whether or not the primary path is available, and more precisely it may indicate whether or not the first MAC entity 164 is available.

In an example embodiment, the indication indicates the temporary condition. In some examples, this may comprise indicating whether or not there is a temporary condition at the primary MAC entity. In some examples, the indication indicates cause of the unavailability. For example, the cause of the unavailability may be used to determine when the primary path is again available. However, in some examples, the MAC explicitly indicates when the temporary condition is over and thus the primary path available again at least from the MAC entity's perspective.

FIG. 7 illustrates an embodiment. Referring to FIG. 7, when data volume equals to or is over the datasplitthreshold value (block 702), the UE may use either of the primary and secondary paths to transmit a PDU during time period 710. In block 704, the data volume is less than datasplitthreshold, and thus the UE may act differently than during block 702. Block 708A illustrates that primary MAC entity and primary path are available. Hence, during 730A, the UE may use primary path to transmit PDUs. UE may not be allowed to use both paths as data volume is less than said threshold.

Arrow 750 illustrates a first indication by the primary MAC entity about the temporary condition (or simply unavailability of the primary MAC entity) to the PDCP entity 150. Based on the indication, the PDCP entity 150 determines that primary MAC entity is not available (block 706). Hence, the PDCP entity 150 may start to submit PDU(s) to the secondary MAC entity.

In an embodiment, the first indication 750 causes PDCP entity 150 to stop submitting one or more PDUs to the primary path, and particularly to the first RLC entity 162 associated with the primary path.

In an embodiment, the first indication 750 causes PDCP entity 150 to start submitting one or more PDUs to both the primary path and the secondary path. Thus, the indication may cause the PDCP entity 150 to start PDU duplication. This may increase reliability of PDU transfer. Once primary path becomes available again, queued PDU(s) may be transmitted also from the primary path in this example.

Arrow 760 illustrates a second indication by the primary MAC entity. The second indication may indicate that the temporary condition is over (or simply primary MAC entity is available). Based on the indication, the PDCP entity 150 determines that primary MAC entity is available (block 708B). Particularly, the PDCP entity 150 may determine that the primary MAC entity and primary path is available again. Accordingly, the second indication 760 causes PDCP entity 150 to start submitting or continue submitting one or more PDUs to the primary path, and particularly to the first RLC entity 162 associated with the primary path.

Thus, during time period 720 (i.e. between the indications 750 and 760), the PDCP entity 150 may transfer or submit PDU(s) to the secondary RLC entity. In an example embodiment, during time period 720 the PDUs are not transmitted to the primary RLC entity (i.e. PDU(s) are prevented from going to the primary path). In another example embodiment, during time period 720 PDU(s) may be transmitted to both primary and secondary paths (i.e. packet duplication example).

During time periods 730A and 730B, the PDCP entity 150 may transfer or submit PDU(s) to the primary RLC entity, but not to the secondary RLC entity (i.e. PDU(s) are prevented from going to the secondary path).

Further benefit here is that if the primary RLC entity is working and available, but the primary MAC entity is not available, then the PDCP entity 150 does not submit PDU(s) at least only to the primary RLC entity as the path as a whole is not available. If it did, those PDU(s) may become stuck in the primary RLC entity at least for the duration of the primary MAC's unavailability. Further, the proposed solution does not require Radio Resource Control (RRC) signaling as it may be purely user-plane mechanism. However, the configuration by the network node (e.g. see FIG. 4) may be done e.g. via RRC. But otherwise the UE may act on its own according to the network configuration.

The examples and embodiments herein describe the proposed solution with using two RLC entities: first RLC entity associated with the primary path and second RLC entity associated with the secondary path. However, the solution may be applicable to other kind of systems as well. For example, the first entity is a first RLC entity and the second entity is a wireless local area network (WLAN) aggregation entity. In an embodiment, the WLAN aggregation entity is a Radio Access Network (RAN)-WLAN Aggregation Adaptation Protocol entity. In an embodiment, said RAN comprises Long Term Evolution (LTE) and/or New Radio (NR). In an embodiment, the WLAN aggregation entity is an LTE-WLAN Aggregation Adaptation Protocol (LWAAP) entity. In this case, the datasplitthreshold may be ul-LWA-DataSplitThreshold. Thus, for example, the proposed solution can be used in split bearer configuration which is targeted to WLAN aggregation scenario. The used terms should be interpreted broadly: i.e. primary path may refer to the RAN path (e.g. LTE path) of the split bearer and secondary path may refer to the WLAN path of the split bearer.

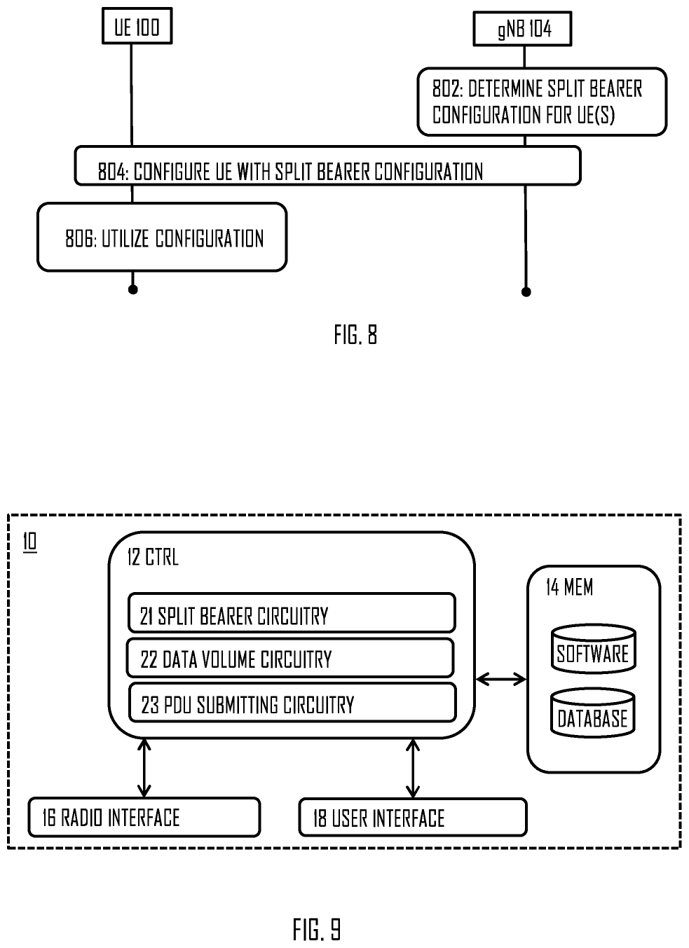

FIG. 8 illustrates a signal diagram according to an embodiment. Referring to FIG. 8, similarly as in block 402 of FIG. 4, the network node (in this case gNB 104) may determine split bearer configuration for one or more UEs. For example, split bearer configuration may be determined for UE 100. The split bearer configuration may be as discussed above (e.g. see FIG. 3 and FIG. 5 and discussion thereof).

In block 804, the gNB 104 may configure the UE 100 with the split bearer configuration. This may be done e.g. via RRC signalling. Thus, the UE 100 may become configured with the split bearer configuration.

In block 806, after the configuration, the UE 100 may act according to the configuration. That is, it may act as discussed above. For example, the UE 100 may perform steps 510, 512, and 514 according to the configuration. For example, in minimum the configuration may indicate that the UE 100 should use secondary path (block 514) if primary path is not available, and data volume does not exceed the datasplitthreshold.

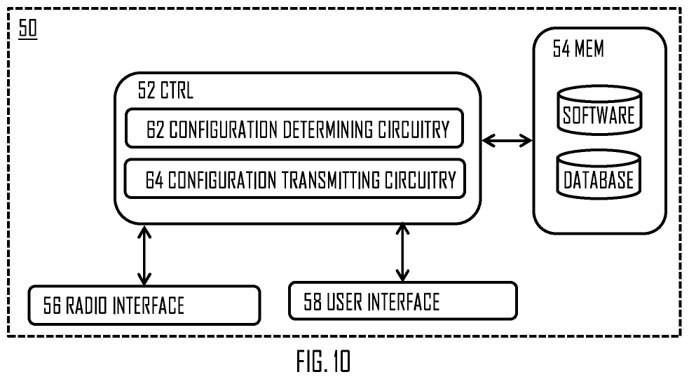

An embodiment, as shown in FIG. 9, provides an apparatus 10 comprising a control circuitry (CTRL) 12, such as at least one processor, and at least one memory 14 including a computer program code (software), wherein the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 may comprise the terminal device of a communication system (such as the communication system of FIG. 1), e.g. a user terminal (UT), a computer (PC), a lap-top, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE 100 or UE 102. The apparatus may be caused to execute some of the functionalities of the above described processes, such as the steps of FIG. 3 and/or FIG. 5. In an embodiment, the apparatus 10 comprises PDCP entity, such as PDCP entity 150, primary RLC entity (e.g. first RLC entity 162), secondary RLC entity (e.g. second RLC entity 172), primary MAC entity (e.g. first MAC entity 164) and/or secondary MAC entity (e.g. second MAC entity 174).

The apparatus may further comprise a radio interface (TRX) 16 comprising hardware and/or software for realizing communication connectivity according to one or more communication protocols. The TRX may provide the apparatus with communication capabilities to access the radio access network, for example. The apparatus may also comprise a user interface 18 comprising, for example, at least one keypad, a microphone, a touch display, a display, a speaker, etc. The user interface may be used to control the apparatus by the user.

The control circuitry 12 may comprise a split bearer circuitry 21 configured at least to perform operations described with reference to block 302; a data volume circuitry 22 configured at least to perform operations described with reference to block 304; and a PDU submitting circuitry 23 configured at least to perform operations described with reference to block 306, 308 and 310 (i.e. submission of PDUs to different paths according to the applied criteria). In some embodiments, the PDU submitting circuitry 23 realises the PDCP entity 150.

An embodiment, as shown in FIG. 10, provides an apparatus 50 comprising a control circuitry (CTRL) 52, such as at least one processor, and at least one memory 54 including a computer program code (software), wherein the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 50 may be or be comprised in a network node, such as in gNB/gNB-CU/gNB-DU of 5G. In an embodiment, the apparatus is or is comprised in the network node 104. The apparatus may be caused to execute some of the functionalities of the above described processes, such as the steps of FIG. 4.

The apparatus may further comprise communication interface (TRX) 56 comprising hardware and/or software for realizing communication connectivity according to one or more communication protocols. The TRX may provide the apparatus with communication capabilities to access the radio access network, for example. The apparatus may also comprise a user interface 58 comprising, for example, at least one keypad, a microphone, a touch display, a display, a speaker, etc. The user interface may be used to control the apparatus by the user.

The control circuitry 52 may comprise a configuration determination circuitry 62 configured at least to perform operations described with reference to block 402; and a configuration transmitting circuitry 64 configured at least to perform operations described with reference to block 404.

In an embodiment, a CU-DU (central unit-distributed unit) architecture is implemented. In such case the apparatus 50 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the radio node may be stand-alone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 50 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s)), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor and at least one memory including computer program code, the at least one memory and computer program code configured to, with the at least one processor, cause the apparatus to perform:
support a split bearer involving a first entity associated with a primary path of the split bearer and a second entity associated with secondary path of the split bearer, wherein the first entity and the second entity are configured for data transfer;
determine a total amount of data volume for the data transfer;
if the total amount of data volume for the data transfer is greater than or equal to a threshold value of the split bearer, submit a Packet Data Convergence Protocol (PDCP) protocol data unit (PDU) to either the first entity or the second entity;
if the total amount of data volume for the data transfer is less than the threshold value of the split bearer,
submit the PDCP PDU to the first entity if the primary path is available to use, and
submit the PDCP PDU to the second entity if the primary path is not available to use.

2. The apparatus of claim 1, wherein the primary path is not available and the unavailability is caused by a temporary condition.

3. The apparatus of claim 2, wherein the temporary condition is associated with MAC entity of the primary path.

4. The apparatus of claim 3, wherein the temporary condition is caused by lack of uplink time alignment.

5. The apparatus of claim 3, wherein the temporary condition is caused by a non-completed random-access procedure.

6. The apparatus of claim 3, wherein the temporary condition is caused by a reset of the MAC entity.

7. The apparatus of claim 3, wherein the temporary condition is indicated by the MAC entity by sending an indication to a PDCP entity.

8. The apparatus of claim 7, wherein the indication causes PDCP entity to stop submitting one or more PDUs to the primary path.

9. The apparatus of claim 2, wherein the temporary condition is determined to be over, wherein the apparatus is further configured to perform:
if the total amount of data volume for the data transfer is less than the threshold value of the split bearer,
prevent submitting a further PDCP PDU to the second entity, and
submit the further PDCP PDU to the first entity.

10. The apparatus of claim 1, wherein the total amount of data volume for the data transfer comprises a total amount of PDCP data volume and data volume pending for initial transmission in the first entity and the second entity.

11. The apparatus of claim 1, wherein the apparatus is further configured to perform:
receive, from a network node, a split bearer configuration that configures the apparatus, if the total amount of data volume for the data transfer is less than the threshold value of the split bearer, to submit the PDCP PDU to the first entity if the primary path is available to use, and to submit the PDCP PDU to the second entity if the primary path is not available to use.

12. An apparatus comprising at least one processor and at least one memory including computer program code, the at least one memory and computer program code configured to, with the at least one processor, cause the apparatus to perform:
determine a configuration for a split bearer for a user equipment (UE) wherein the split bearer involves a first entity associated with a primary path of the split bearer and a second entity associated with secondary path of the split bearer, and wherein the first entity and the second entity are configured for data transfer; and
transmit the split bearer configuration to the UE, wherein the split bearer configuration causes the UE, if the total amount of data volume for a data transfer is less than the threshold value of the split bearer, to submit a Packet Data Convergence Protocol (PDCP) protocol data unit (PDU) to the first entity if the primary path is available to use, and to submit the PDCP PDU to the second entity if the primary path is not available to use.

13. (canceled)

14. A method for a user equipment (UE) the method comprising:
supporting a split bearer involving a first entity associated with a primary path of the split bearer and a second entity associated with secondary path of the split bearer, wherein the first entity and the second entity are configured for data transfer;
determining a total amount of data volume for the data transfer;
if the total amount of data volume for the data transfer is greater than or equal to a threshold value of the split bearer, submitting a Packet Data Convergence Protocol (PDCP) protocol data unit (PDU) to either the first entity or the second entity; and
if the total amount of data volume for the data transfer is less than the threshold value of the split bearer,
submitting the PDCP PDU to the first entity if the primary path is available to use, and
submitting the PDCP PDU to the second entity if the primary path is not available to use.

15-17. (canceled)
